(19) United States
(12) Patent Application Publication
(10) Pub. No.: US 2013/0204497 A1
(43) Pub. Date: Aug. 8, 2013

(54) USER-BASED AUTOMOTIVE CABIN VENTILATION SETTINGS

(71) Applicant: Matthew DePetro, Sunnyvale, CA (US)

(72) Inventor: Matthew DePetro, Sunnyvale, CA (US)

(73) Assignee: FUJITSU LIMITED, Kanagawa (JP)

(21) Appl. No.: 13/366,889

(22) Filed: Feb. 6, 2012

(51) Int. Cl. G06F 7/00

(52) U.S. Cl. 701/49; 701/36

(57) ABSTRACT

An automobile may comprise a user interface, a ventilation system, a memory, and a controller. The user interface may be configured to detect presence of a user in the automobile. The ventilation system may comprise at least one vent, the at least one vent comprising an aperture comprising an opening configured to limit an amount of air that can pass through the at least one vent and at least one set of air flow fins configured to control a direction of air expelled by the at least one vent. The controller may be coupled to the memory, the user interface, and the ventilation system and configured to receive from the user interface an indication of the presence of the user, read desired ventilation settings associated with the user stored in memory; and communicate at least one signal to the ventilation system indicative of the desired ventilation settings.

### TECHNICAL FIELD

The present disclosure relates generally to automotive vehicles, more particularly, to user-based automotive cabin ventilation settings.

### BACKGROUND

Traditionally, automobiles have included ventilation systems configured to provide heating and/or air conditioning to occupants of automobile cabins. Typically, such vehicles have allowed users to manually adjust various ventilation settings, such as cabin temperature, fan speed, air flow direction, and air flow aperture.

### SUMMARY

In accordance with some embodiments of the present disclosure, an automobile may comprise a user interface, a ventilation system, a memory, and a controller. The user interface may be configured to detect presence of a user in the automobile. The ventilation system may comprising at least one vent, the at least one vent comprising an aperture comprising an opening configured to limit an amount of air that can pass through the at least one vent and at least one set of air flow fins configured to control a direction of air expelled by the at least one vent. The controller may be communicatively coupled to the memory, the user interface, and the ventilation system and configured to receive from the user interface an indication of the presence of the user, read desired ventilation settings associated with the user stored in the memory, and communicate at least one signal to the ventilation system indicative of the desired ventilation settings associated with the user.

Technical advantages of the present disclosure may be readily apparent to one skilled in the art from the figures, description and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a block diagram of selected components of an example automobile, in accordance with embodiments of the present disclosure; and

FIG. 2 illustrates a flow chart of an example method of automatically applying user-based automotive cabin ventilation settings, in accordance with embodiments of the present disclosure.

### DETAILED DESCRIPTION

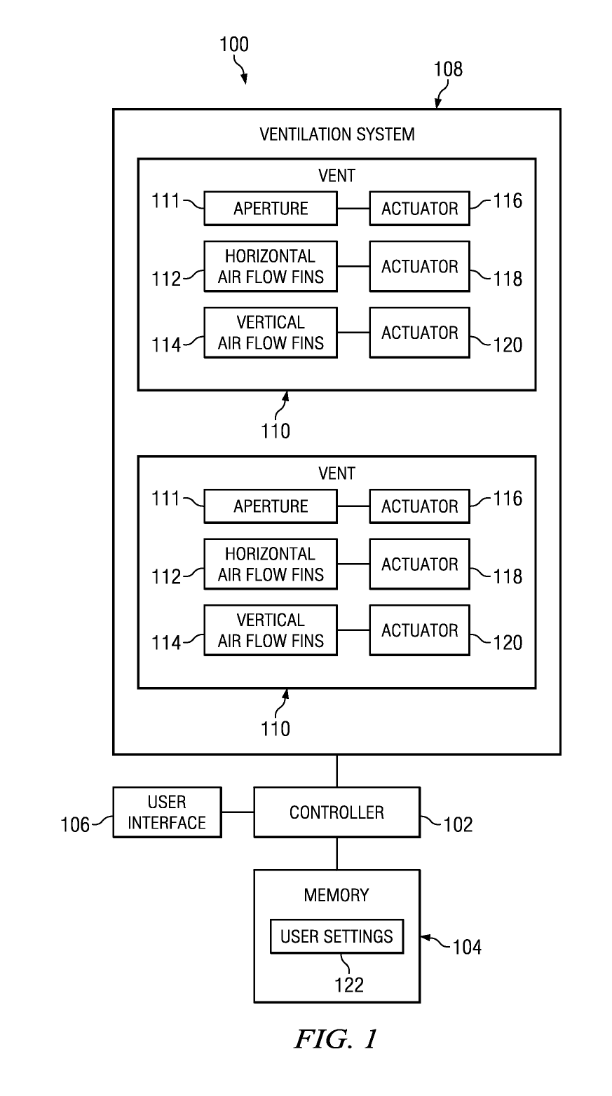

FIG. 1 illustrates a block diagram of selected components of an example automobile 100, in accordance with embodiments of the present disclosure. Automobile 100 may broadly represent any system, device, or apparatus configured or used to transport persons and/or cargo in whole or in part on land, including without limitation a passenger automobile (e.g., a car, truck, sport utility vehicle, van, bus, motorcycle, coach, etc.), a train, a trolley, an aircraft, a spacecraft, an amphibious watercraft, industrial equipment (e.g., a forklift, cart, etc.), and/or any other suitable vehicle. As depicted in FIG. 1, automobile 100 may include a controller 102, a memory 104, a user interface 106, and a ventilation system 108.

Controller 102 may be communicatively coupled to memory 104, user interface 106, ventilation system 108, and/or other components of automobile 100. Controller 102 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, controller 102 may interpret and/or execute program instructions and/or process data stored in memory 104 and/or another component of automobile 100. In operation, controller 102 may receive from and/or communicate to other components of automobile 100 in order to identify a user based on received identifying characteristics of a user and control components of automobile 100 in order to apply user-specific environment settings associated with such components, as described in greater detail below.

Memory 104 may be electrically coupled to controller 102 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory. In certain embodiments, memory 104 may store user settings 122. User settings 122 may include a table, map, list, database, or other data structure setting forth individual users of automobile 100 and/or ventilation system settings for each user.

User interface 106 may be communicatively coupled to controller 102 and may include any system, device, or apparatus configured to receive input from a user to allow the user to control or manipulate automobile 100 and its various components and/or display user-readable output allowing automobile 100 to indicate effects of such user manipulation. For example, user interface 106 may include a display device, keyboard, keypad, buttons, switches, and/or other devices. In operation, user interface 106 may receive or facilitate receipt of user input indicating a user's desired ventilation settings and/or receive input from a user to indicate presence of the user in automobile 100 (e.g., a manual input such as depressing a button, by automatic detection of the user based on one or more physical characteristics of the user, or other suitable manner). In some embodiments, user interface 106 may comprise an interactive voice command system, wherein a user may use verbal commands to manipulate ventilation settings and/or store such ventilation settings to a memory (e.g., memory 104). In yet another embodiment, a user may manually point the horizontal air flow fins 112 vertical air flow fins 114 and manually adjusting aperture 111 and interacting with user interface 106 (e.g., pushing a button) to record/store the manually adjusted parameters to memory 104.

Ventilation system 108 may be communicatively coupled to controller 102 and may include any suitable climate control system (e.g., air conditioning, heating, defrosting and defogging of windows, seat warmers, etc.). Ventilation system 108 may be configured to, in response to signals received from controller 102 indicative of user preferences set forth in user settings 122, apply operational parameters for ventilation system 108 in accordance with the user preference, as described in greater detail below. For example, based on user preference set forth in user settings 122, ventilation system 108 may control temperature, fan speed, enable or disable particular vents, adjust direction of airflow from vents, and/or other parameters, as described in greater detail below.

As shown in FIG. 1, ventilation system 108 may include, among other components, one or more vents 110. A vent 110 may include any system, device, or apparatus configured to diffuse and/or direct air from a duct (not explicitly shown in FIG. 1), blower (not explicitly shown in FIG. 1), or other suitable component. To control air flow, a vent 110 may include an aperture 111, horizontal air flow fins 112, and vertical air flow fins 114.

An aperture 111 may include any suitable user-adjustable opening that limits an amount of air that can pass through. As shown in FIG. 1, an aperture 111 may be mechanically coupled to an associated actuator 116. An actuator 116 may include any system, device, or apparatus (e.g., any combination of motors, belts, pulleys, and/or other drive components), configured to, in response to signals received from controller 102 translate one or more portions of aperture 111 to set the opening of aperture 111 to a particular size.

Horizontal air flow fins 112 may include one or more user-adjustable fins, slats, or other members that may control a horizontal direction of air expelled by vent 110. As shown in FIG. 1, horizontal air flow fins 112 may be mechanically coupled to an associated actuator 118. An actuator 118 may include any system, device, or apparatus (e.g., any combination of motors, belts, pulleys, and/or other drive components), configured to, in response to signals received from controller 102 translate one or more portions of horizontal air flow fins 112 to set horizontal air fins 112 in a particular orientation.

Vertical air flow fins 114 may include one or more user-adjustable fins, slats, or other members that may control a vertical direction of air expelled by vent 110. As shown in FIG. 1, vertical air flow fins 112 may be mechanically coupled to an associated actuator 120. An actuator 120 may include any system, device, or apparatus (e.g., any combination of motors, belts, pulleys, and/or other drive components), configured to, in response to signals received from controller 102 translate one or more portions of vertical air flow fins 114 to set horizontal air fins 114 in a particular orientation.

In operation, a user interacting with user interface 106 may provide input indicative of desired parameters associated with ventilation system 108 (e.g., aperture 111 size, orientations of horizontal air flow fins 112 and vertical air flow fins 114, etc.). Controller 102 may receive such input and further communicate signals to ventilation system 108 to apply the desired parameters to components of ventilation system 108 (e.g., communicate signals to actuators 116, 118, and/or 120 to translate portions of aperture 111, horizontal air flow fins 112, and/or vertical air flow fins 114 in accordance with the user's desired parameters).

In addition, a user interacting with user interface 106 may provide input indicative of a desire to store desired parameters associated with ventilation system 108 to memory 104 for later recall. In response to such input, controller 102 may store to memory the desired parameters to user settings 122 of memory 104.

Furthermore, stored desired parameters for ventilation system 108 and associated with a particular user may be recalled from user settings 122 and applied to components of ventilation system 108. For example, user interface 106 may receive an input indicative of the presence of a user. In some embodiments, such input may be a manual push of a button or similar device by the user. In these and other embodiments, such input may be a physical characteristic of the user (e.g., weight, height, body frame type, fingerprint, palm vein, facial features, and/or other biometric indicator) or an item on the user's person (e.g., identifying information regarding an electronic device carried by the user wirelessly communicated from the device to a communication module of automobile 100). User interface 106 may communicate such input to controller 102, and in response to the input indicative of the presence of the user, controller 102 may read desired ventilation settings associated with such the user from user settings 122 of memory 104, provided an entry for such user exists in user settings 122. Controller 102 may then communicate signals to ventilation system 108 to apply the desired parameters retrieved from memory 104 to components of ventilation system 108 (e.g., communicate signals to actuators 116, 118, and/or 120 to translate portions of aperture 111, horizontal air flow fins 112, and/or vertical air flow fins 114 in accordance with the user's desired parameters).

As used herein, “user” may broadly refer to any occupant of a vehicle, including a driver or passenger.

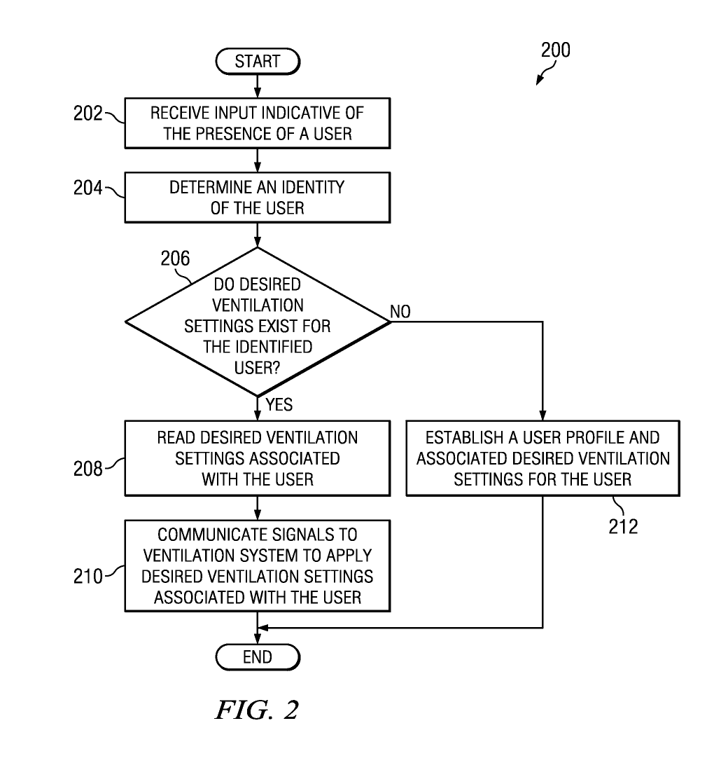

FIG. 2 illustrates a flow chart of an example method 200 of automatically applying user-based automotive cabin ventilation settings, in accordance with embodiments of the present disclosure. According to one embodiment, method 200 may comprise steps 202-212. As noted above, teachings of the present disclosure may be implemented in a variety of configurations of automobile 100. As such, the preferred initialization point for method 200 and the order of the steps 202-212 comprising method 200 may depend on the implementation chosen.

At step 202, user interface 106 may receive input indicative of the presence of a user (e.g., manual input from a user or automatic receipt of physical characteristics of a user or an item carried by the user). At step 204, based on the received input and/or information stored within user settings 122 of memory 104, controller 102 may determine an identity of the user.

At step 206, controller 102 may determine if desired ventilation settings exist in user settings 122 for the identified user. If desired ventilation settings do not exist for the identified user, method 200 may proceed to step 212. If desired ventilation settings do exist for the identified user, method 200 may proceed to step 208.

At step 208, in response to a determination that desired ventilation settings do exist for the identified user, controller 102 may read desired ventilation settings associated with the user from user settings 122. At step 210, controller 102 may, based on the desired ventilation settings associated with the user, communicate signals to one or more components of ventilation system 108 (e.g., actuators) such that the one or more components apply desired ventilation settings associated with the user. After completion of step 210, method 200 may end.

At step 212, in response to a determination that desired ventilation settings do not exist for the identified user, controller 102 may, via user interface 106, interact with the user to establish a user profile and associated desired ventilation settings for the user and store such profile and desired ventilation settings to user settings 122 of memory 104. After completion of step 212, method 200 may end.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using controller 102 and/or or any other system, device, or apparatus operable to implement method 200. In certain embodiments, method 200 may be implemented partially or fully in software and/or firmware embodied in computer-readable media.

A component of automobile 100 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Herein, “each” refers to each member of a set or each member of a subset of a set.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An automobile comprising:
a user interface configured to detect presence of a user in the automobile;
a ventilation system comprising at least one vent, the at least one vent comprising:
an aperture comprising an opening configured to limit an amount of air that can pass through the at least one vent; and
at least one set of air flow fins configured to control a direction of air expelled by the at least one vent;
a memory;
a controller communicatively coupled to the memory, the user interface, and the ventilation system and configured to:
receive from the user interface an indication of the presence of the user;
determine an identity of the user;
read desired ventilation settings associated with the identified user stored in the memory; and
communicate at least one signal to the ventilation system indicative of the desired ventilation settings associated with the user.

2. An automobile according to claim 1, the at least one set air flow fins comprising a set of horizontal air flow fins configured to control a horizontal direction of air expelled by the at least one vent.

3. An automobile according to claim 1, the at least one set of air flow fins comprising a set of vertical air flow fins configured to control a vertical direction of air expelled by the at least one vent.

4. An automobile according to claim 1, wherein:
the user interface is further configured to receive input from the user indicative of desired parameters associated with the ventilation system; and
the controller is further configured to communicate signals to the ventilation system indicative of the desired parameters.

5. An automobile according to claim 4, the desired parameters comprising at least one of:
a desired size of the aperture; and
a desired orientation of the at least one set of air flow fins.

6. An automobile according to claim 1, the desired ventilation settings comprising at least one of:
a desired size of the aperture; and
a desired orientation of the at least one set of air flow fins.

7. An automobile according to claim 1, the ventilation system comprising at least one actuator configured to:
receive the at least one signal indicative of the desired ventilation settings associated with the user; and
in response to the at least one signal, translate one or more portions of the aperture to set the opening of aperture to a particular size defined by the desired ventilation settings.

8. An automobile according to claim 1, the ventilation system comprising at least one actuator configured to:
receive the at least one signal indicative of the desired ventilation settings associated with the user; and
in response to the at least one signal, translate one or more portions of the at least one set of air flow fins to set the at least one set of air flow in a particular orientation defined by the desired ventilation settings.

9. A method comprising:
receiving from a user interface an indication of the presence of a user of an automobile;
determining an identity of the user;
reading desired ventilation settings associated with the identified user from a memory; and
communicating at least one signal to a ventilation system comprising at least one vent, the at least one signal indicative of the desired ventilation settings associated with the user, the desired ventilation settings comprising at least one of:
a desired size of an aperture comprising an opening configured to limit an amount of air that can pass through the at least one vent; and
a desired orientation of the at least one set of air flow fins configured to control a direction of air expelled by the at least one vent.

10. A method according to claim 9, the at least one set air flow fins comprising at least one of:
a set of horizontal air flow fins configured to control a horizontal direction of air expelled by the at least one vent; and
a set of vertical air flow fins configured to control a vertical direction of air expelled by the at least one vent.

11. A method according to claim 9, further comprising:
receiving from the user interface input from the user indicative of desired parameters associated with the ventilation system; and
communicating signals to the ventilation system indicative of the desired parameters.

12. A method according to claim 11, the desired parameters comprising at least one of:
a desired size of the aperture; and
a desired orientation of the at least one set of air flow fins.

13. A method according to claim 9, the ventilation system comprising at least one actuator configured to:
receive the at least one signal indicative of the desired ventilation settings associated with the user; and
in response to the at least one signal, translate one or more portions of the aperture to set the opening of aperture to a particular size defined by the desired ventilation settings.

14. A method according to claim 1, the ventilation system comprising at least one actuator configured to:
receive the at least one signal indicative of the desired ventilation settings associated with the user; and
in response to the at least one signal, translate one or more portions of the at least one set of air flow fins to set the at least one set of air flow in a particular orientation defined by the desired ventilation settings.

15. An article of manufacture, comprising:
a computer readable medium; and
computer-executable instructions carried on the computer readable medium, the instructions readable by a processor, the instructions, when read and executed, for causing the processor to:
receive from a user interface an indication of the presence of a user of an automobile;
determine an identity of the user;
read desired ventilation settings associated with the identified user from a memory; and
communicate at least one signal to a ventilation system comprising at least one vent, the at least one signal indicative of the desired ventilation settings associated with the user, the desired ventilation settings comprising at least one of:
a desired size of an aperture comprising an opening configured to limit an amount of air that can pass through the at least one vent; and
a desired orientation of the at least one set of air flow fins configured to control a direction of air expelled by the at least one vent.

16. An article of manufacture according to claim 15, the at least one set air flow fins comprising at least one of:
a set of horizontal air flow fins configured to control a horizontal direction of air expelled by the at least one vent; and
a set of vertical air flow fins configured to control a vertical direction of air expelled by the at least one vent.

17. An article of manufacture according to claim 15, the instructions for further causing the processor to:
receive from the user interface input from the user indicative of desired parameters associated with the ventilation system; and
communicate signals to the ventilation system indicative of the desired parameters.

18. An article of manufacture according to claim 17, the desired parameters comprising at least one of:
a desired size of the aperture; and
a desired orientation of the at least one set of air flow fins.

19. An article of manufacture according to claim 15, the ventilation system comprising at least one actuator configured to:
receive the at least one signal indicative of the desired ventilation settings associated with the user; and
in response to the at least one signal, translate one or more portions of the aperture to set the opening of aperture to a particular size defined by the desired ventilation settings.

20. An article of manufacture according to claim 15, the ventilation system comprising at least one actuator configured to:
receive the at least one signal indicative of the desired ventilation settings associated with the user; and
in response to the at least one signal, translate one or more portions of the at least one set of air flow fins to set the at least one set of air flow in a particular orientation defined by the desired ventilation settings.
